(19) United States
(12) Patent Application Publication
(10) Pub. No.: US 2018/0121348 A1
(43) Pub. Date: May 3, 2018

(54) Automatic Garbage Collection for Distributed Storage

(71) Applicant: Microsoft Technology Licensing, LLC, Redmond, WA (US)

(72) Inventor: Atri Sharma, Bangalore (IN)

(21) Appl. No.: 15/339,572

(22) Filed: Oct. 31, 2016

(51) Int. Cl. G06F 12/02; G06F 17/30

(52) U.S. Cl. CPC G06F 12/0253; G06F 2212/702; G06F 17/30303

(57) ABSTRACT

Scheduling garbage collection operations. A set of nodes are identified in a cluster. A relative factor of the nodes in the set of nodes is identified. A target length of time in which to complete a garbage collection process is identified. A subset of the set of nodes in which the garbage collection process could be completed in the identified target length of time is selected. Selecting the subset includes selecting nodes for the garbage collection process based on the relative factor and a probability that the garbage collection process will be completed within the identified target length of time while attempting to maximize an amount of garbage that can be collected. Garbage collection on the subset of the set of nodes is initiated.

### BACKGROUND

### Background and Relevant Art

Computers and computing systems have affected nearly every aspect of modern living. Computers are generally involved in work, recreation, healthcare, transportation, entertainment, household management, etc.

Further, computing system functionality can be enhanced by a computing systems' ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing systems.

Interconnection of computing systems has facilitated distributed computing systems, such as so-called “cloud” computing systems. In this description, “cloud computing” may be systems or resources for enabling ubiquitous, convenient, on-demand network access to a shared pool of configurable computing resources e.g., networks, servers, storage, applications, services, etc.) that can be provisioned and released with reduced management effort or service provider interaction. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

With the growth of cloud based applications, has risen the need for remote storage and distributed storage which might not be in complete control of the user. This might also mean that the user is able to access the storage only through remote API calls. As such, a given file may be split over multiple machines. The extents of a file may be shared. There is no data locality. Multiple scans over existing data may be expensive. And real time processing is needed such that latency is an issue. These issue may particularly affect the efficiency with which garbage collection can be accomplished. Garbage collection is a storage management process that includes processes for identifying storage locations which have stored objects, but for which the objects are no longer valid in that the objects are no longer in use by computer programs. Garbage collection will free up those storage locations and make them available for storage of other data.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a computer implemented method that may be practiced in a cluster, computing environment. The method includes acts for scheduling garbage collection operations. A set of nodes are identified in a cluster. A relative factor of the nodes in the set of nodes is identified. A target length of time in which to complete a garbage collection process is identified. A subset of the set of nodes in which the garbage collection process could be completed in the identified target length of time is selected. Selecting the subset includes selecting nodes for the garbage collection process based on the relative factor and a probability that the garbage collection process will be completed within the identified target length of time while attempting to maximize an amount of garbage that can be collected. Garbage collection on the subset of the set of nodes is initiated.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a cluster computing system;

FIG. 2 illustrates a subset of nodes from the cluster computing system; and

FIG. 3 illustrates a method of performing garbage collection.

### DETAILED DESCRIPTION

Embodiments illustrated herein are directed to performing garbage collection for non-local data and/or massive data. Data, when present on non-local systems, is not under local control and data manipulation normally happens through API calls. In this context, embodiments can improve garbage collection for massive, remote storage. This can be accomplished by careful selection of cloud nodes, (i.e., data processing entities) on which to perform garbage collection (i.e., reclamation of storage occupied by unused data objects). In particular, embodiments can identify a relative factor value for nodes in a set of nodes. For example, the ‘hotness’ (i.e., the frequency of data access) of nodes in a set of nodes can be identified. Additionally, an amount of time allocated for garbage collection may be identified. For example, this may be done by evaluating a Service Level Agreement (SLA) or other time or resource constraint. A subset of the set of nodes is identified in which garbage collection is identified as having a threshold probability of being able to be completed in the identified target length of time. Identifying the subset includes selecting nodes for evaluation based on the relative factor and the probability that garbage collection will be completed within the identified target length of time while attempting to maximize an amount of garbage that can be collected. Garbage collection is then started on the nodes in the identified subset. Some embodiments may further include continued monitoring which identifies that the subset will probably no longer be able to be garbage collected in the target length of time. An alarm can be generated when this occurs. In this case a new subset can be identified. Alternatively, an additional thread can be initiated to perform garbage collection operations to garbage collect the subset of nodes.

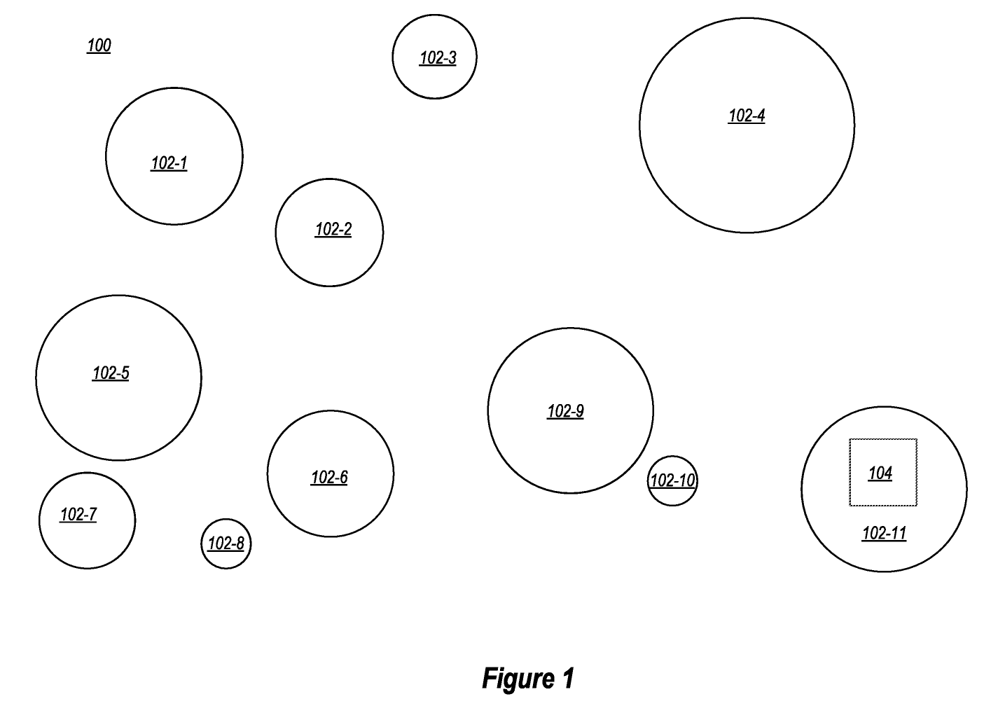

Referring now to FIG. 1, an example is illustrated. FIG. 1 illustrates a cloud cluster 100. FIG. 1 further illustrates a plurality of nodes 102-1 through 102-11 in the cluster 100. While the example shows a set number of nodes, it should be appreciated that virtually any number of nodes may be implemented in a cluster 100. Indeed, the number of nodes in the cluster may be dynamic and the number of nodes in a cluster may increase or decrease over time. The nodes (referred to herein generically as 102) are processing points in the cluster 100. Thus, the nodes may include compute resources, and storage resources, along with networking resources configured to interconnect the various nodes to each other.

In the illustrated example, the nodes are illustrated with different sizes. The sizes are shown to illustrate differences in relative factor values between the different nodes 102. For example, if the relative factor value is a hotness factor, the size of the node represents how frequently data is accessed on the node, with larger sizes representing having data accessed on the node more frequently than smaller sizes. It can be appreciated, that hotter nodes may generate more garbage that needs to be collected by garbage collection processes. While this example illustrates differences in hotness, other embodiments may have a relative factor value that defines recentness of garbage collection, total size of the disk space of a node etc.

As will be illustrated below, the relative factor value can be used to define the probability of inclusion of a node in the subset of nodes to be garbage collected. While some embodiments only use the hotness of a node to predict the number of objects for garbage collection a node may have, other embodiments may use a cost based model, which factors in multiple factors like hotness, recentness of garbage collection, total size of the disk space of node etc. can be used together. Still, in other embodiments, a user can add their own parameters, which will affect the garbage collector performance, so a garbage collector can be user tunable. Thus, different relative factor values may be combined in some embodiments to an Uber relative factor value. This Uber relative factor value can then be used to optimize garbage collection.

As noted, embodiments may include functionality for performing garbage collection on the storage resources of the nodes 102. This may be accomplished by starting a separate Garbage Collector (GC) daemon 104 when the cluster 100 is initiated. In the illustrated example the GC daemon 104 is implemented on a coordinator node 102-11. This GC daemon 104 will be responsible for collection of all metadata about deletion of a data object. This GC daemon 104, in some embodiments, runs throughout the life of the cluster 100. This GC daemon 104 is preferably multi-threaded, meaning that multiple garbage collection operations can be performed substantially simultaneously. As a data object is inserted into storage at one of the nodes 102 in the cluster, an entry will be made to the GC daemon 104. The GC daemon 104 will initiate an empty forest graph including that new data object as the only single node. As references are made to the object, the graph is populated in the GC daemon's metadata store. The nodes may be maintained in an indexed adjacency list format which allows for fast retrieval.

Periodically, a multi-threaded, depth first search will be run on the graph by the GC daemon 104 which will identify any disconnected objects in the graph. Any forest of size 1 can be garbage collected to remove the corresponding object and free the associated storage for other uses. As references are deleted, corresponding edges in the GC daemon's metadata store graph will be deleted.

As noted, embodiments may attempt to optimize garbage collection to attempt to collect as much garbage as possible while still complying with time constraints such as those specified in SLAs. In some embodiments, this may be done by using relative factor values, time for garbage collection to move from node to node, and time constraints (such as SLAs) to identify a set of nodes on which to begin garbage collection.

Consider the following example:

Let s be the set of nodes 102 in the cluster 100

Let A1 . . . An (nodes 102-1 through 102-10, in the illustrated example) be the nodes present in the cluster 100.

Let the coordinator node be A0 (node 102-11, in the illustrated example).

Let the total time allocated for Garbage Collection be t.

Let the relative factor value table which maintains relative factor values (e.g., the hotness of each node's access) be P. Note that in some embodiments. P is not holding the actual counts, it is just a splay tree which has a priority queue of nodes in order of relative factor value (e.g., frequency of reference requests in the hotness example, disk size in the disk size example, etc.). P cannot be used deterministically for the GC process as P can be very large and does not have exact counts of references, so a node might be explicitly deleted and needs to be garbage collected even if it has a larger relative factor value as compared to other nodes.

Embodiments may model the SLA for each node in terms of the time starting point for garbage collection for each node. For example, assume that the communication time between two nodes is dn and it is fixed. This does not consider hops in the cluster nodes.

In the illustrated example, the probability of Node i being in the set of nodes to be evaluated in the garbage collection process in this run is p(i). Two parameters are defined for the illustration: start(i, tₛ) and end(i, t_{c}). Start(i, tₛ) is the probablility that the garbage collector will start on Node i at time tₛ and end(i, t_{c}) is the probability that garbage collection will end on Node i at time t_{c}.

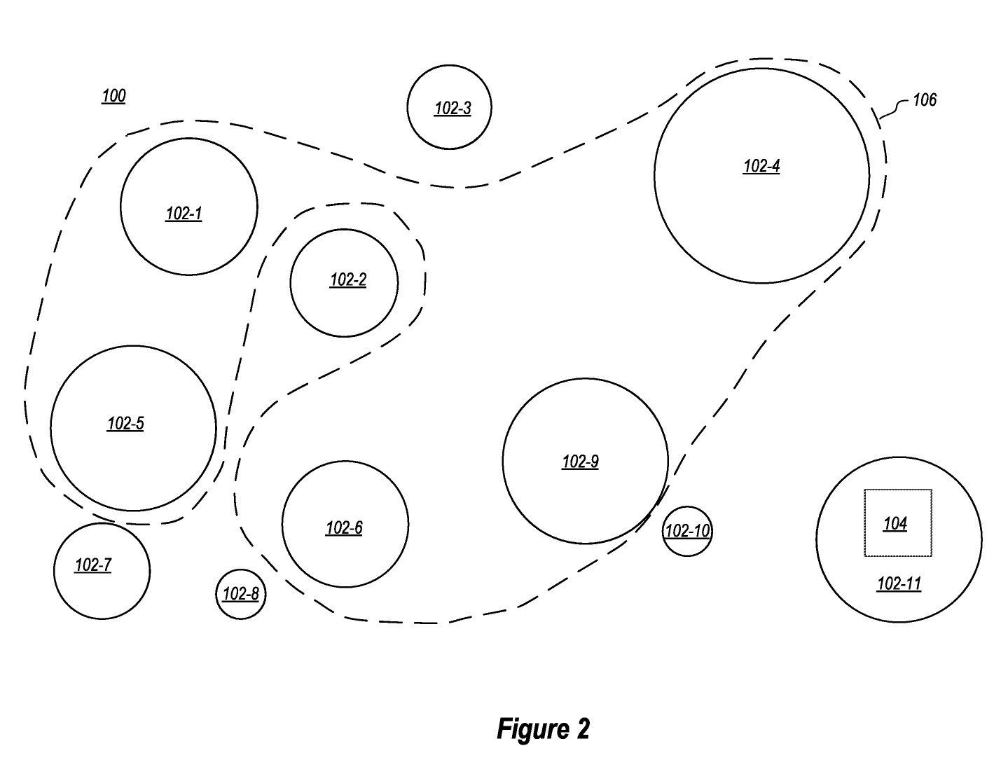

B (illustrated as subset 106 in FIG. 2) is the subset of nodes currently selected for garbage collection evaluation. Initially, B is empty. Starting of a garbage collection process from the coordinator node 102-11 occurs at Time 0. The total time allocated for garbage collection is T. An assumption can be made that the SLA time for starting garbage collection on Node i is ((dn*(total nodes visited before i)).

Ti is the total time starting from Time 0 taken to start the garbage collection process at Node i.

Ti(max)=When all nodes are visited before i

Ti(min)=When none of the nodes are visited before i

Note that if Ti exceeds (T/(Count(n)*(number of nodes visited before i)), a node level breach has occurred. This means that the SLA for a given node was not met. However, this does not constitute a global breach (i.e., the total time for the entire subset is not exceeded and thus an SLA for the entire subset has not vet been exceed). Thus, even when a node level breach occurs, embodiments can catch up on the total time to meet subset level SLAs. How this is accomplished is covered in more detail below.

The probability that the garbage collector will start on Node i at time tₛ is given by Start (i, t)=Summation of (Probability that i is being included in B* Probability that the end time of Garbage Collection process in previous node in B is (t-dn))*Sigma of (probability that none of the nodes between 1 and i are added in B), or more formally:

$$start ( i , t ) = {\sum }_{k = 0}^{i - 1} pk \times end ( k , t - k \times dn ) ) \times {\prod }_{m = k + 1}^{i} - 1 ( 1 - pm )$$

The probability that garbage collection will end on Node i at time t_{c} is given by:

End(i,t)=(0 if t<(T/count(n)*(dn*i))

Summation (Start(i,t)) if t=(T/count(n)*(dn*j))

Start(i,t) if t>(T/count(n)*(dn*j))

A final objective equation is given by:

$$g ( i , t ) = {\sum }_{v = 1}^{i - 1} {p}_{v} h ( v , t - {d}_{v , i} ) {\prod }_{k = v + 1}^{i - 1} ( 1 - pk )$$

The probability of inclusion of a node in B is directly derived from the relative factor value table maintained. This can just be a priority queue or can be a histogram of distribution of data where the graph is used to determine the relative factor value of a node.

Maximizing this equation g(i,t) will identify the nodes in the subset B (e.g., subset 106 in the illustrated example), which is the set of nodes for which garbage collection will be begun.

Thus, once the subset 106 is identified, garbage collection can be begun on that subset.

Note that the order of nodes being visited matters in the performance of the garbage collection. In some embodiments, a user can configure a node priority and topologically sort the nodes that are fed to the algorithm in order of priority. For example, inherent priorities that can be used may include sorting based on node storage size, last garbage collected, etc.

Note that the above computation illustrates one computation that may be performed by the GC daemon 104 to identify a subset of nodes on which to perform garbage collection. However, it should be appreciated that other types of analysis could be performed alternatively or additionally to identify a subset of nodes on which to perform garbage collection. For example, embodiments could use an ant colony optimization for identifying the nodes to which the maximum amount of nodes are connected, which will be most used edge.

Note, however, that certain circumstances may result in garbage collection on the subset 106 to not be accomplished within the time t. Some embodiments may implement a warning triggered by a warning level trigger. A warning level function determines the performance of the GC given SLA performance at a particular time and can emit a warning level trigger. This trigger can be used to initiate mitigation steps. Such mitigation steps may include adjusting the subset of nodes on which garbage collection is performed to attempt to meet the SLA performance targets. Alternatively or additionally, a mitigation step may include assigning additional threads to the garbage collection processes. As noted previously, garbage collection processes may be performed by a multi-threaded garbage collector that is able to allocate additional threads to the garbage collection processes. If additional threads are needed to meet SLA or other time requirements, these can be allocated as needed to meet the SLA or other time requirements.

The following illustrates a computation that may be performed by the GC daemon 104 to determine if a warning level trigger should be emitted:

$$WarningLevel ( i , t ) = {\sum }_{i = 1}^{n} {p}_{i} \times {\sum }_{t = k}^{allocated time} Ti ( max ) ( warningconstant ( i , t ) \times ( k - allocated time )$$

This equation calculates the probability of failure to achieve the SLA defined. The elements are the starting times of GC on the nodes, the ending time and the size of the cluster. The higher the probability of failure, the higher the warning level. The constant is a factor that defines a desired alert level. For example, to be highly conservative, a higher constant is used.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

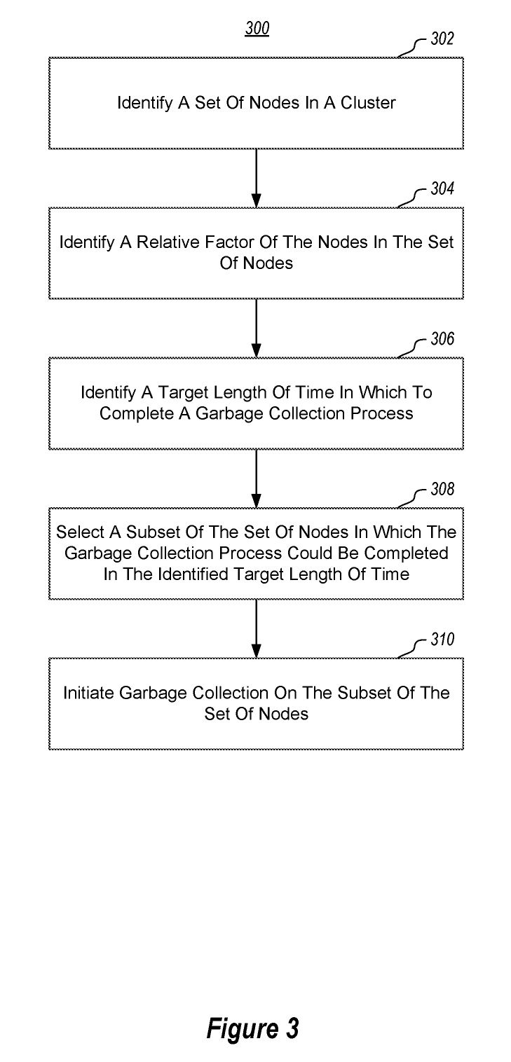

Referring now to FIG. 3, a method 300 is illustrated. The method 300 may be practiced in a cluster, computing environment. The method 300 includes a computer implemented method of scheduling garbage collection operations. The method 300 includes identifying a set of nodes in a cluster (act 302).

The method 300 further includes identifying a relative factor of the nodes in the set of nodes (act 304).

The method 300 further includes identifying a target length of time in which to complete a garbage collection process (act 306). For example, this may be identified based on some SLA or other time constraint.

The method 300 further includes selecting a subset of the set of nodes in which the garbage collection process could be completed in the identified target length of time (act 308). Selecting the subset comprises selecting nodes for the garbage collection process based on the relative factor and a probability that the garbage collection process will be completed within the identified target length of time while attempting to maximize an amount of garbage that can be collected.

The method 300 further includes beginning garbage collection on the subset of the set of nodes (act 310).

The method 300 may be practiced where identifying a relative factor includes identifying node hotness which identifies rates at which data is accessed on nodes. In some embodiments, nodes may be prioritized by inverse hotness to prioritize selection of nodes for evaluation to determine if garbage collection should be performed. Although in other embodiments, node may be prioritized by hotness. Nodes with higher prioritization are more likely to be selected for the subset than nodes with lower prioritization.

The method 300 may be practiced where identifying a relative factor comprises identifying when garbage collection was last performed on nodes. Thus, for example, in some embodiments, nodes that have had garbage collection performed on them more recently are prioritized lower than nodes that have had garbage collection performed on them less recently. Nodes with higher prioritization are more likely to be selected for the subset than nodes with lower prioritization.

The method 300 may be practiced where wherein identifying a relative factor comprises identifying storage space on nodes. Thus, for example, nodes with more storage space may be prioritized higher than nodes with less storage space. More storage space may be an indicator of more garbage to be collected. Nodes with higher prioritization are more likely to be selected for the subset than nodes with lower prioritization.

The method 300 may further include generating a warning indicating that the target length of time will not be met if the current subset is garbage collected. For example, as illustrated above, the GC daemon 104 may periodically compute a warning level, and when the warning level exceeds a predetermined threshold, a warning can be emitted indicating that an SLA is unlikely to be met if garbage collection continues as scheduled on the selected subset.

In some such embodiments, a corrective action be performed including, based on the warning, selecting a different subset. In particular, a new subset with fewer nodes or less garbage to be collected can be identified and selected. Garbage collection can be begun on the new subset.

Alternatively or additionally, corrective action may be performed, including, based on the warning, identifying independent nodes in the subset and beginning garbage collection on the independent nodes in the subset. An independent node is one in which objects on the node do not reference objects on other nodes. Parallel processing can be performed on the independent nodes to make up garbage collection processes to meet the target length of time. Nodes can be sorted for processing in topological order where the ones with maximum references to other nodes are sorted first. In some embodiments, the nodes with higher numbers of references to other nodes are processed before nodes with fewer references.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system comprising:
one or more processors; and
one or more computer-readable media having stored thereon instructions that are executable by the one or more processors to configure the computer system to schedule garbage collection operations, including instructions that are executable to configure the computer system to perform at least the following:
identify a set of nodes in a cluster;
identify a relative factor of the nodes in the set of nodes;
identify a target length of time in which to complete a garbage collection process;
select a subset of the set of nodes in which the garbage collection process could be completed in the identified target length of time, wherein identifying the subset comprises selecting nodes for the garbage collection process based on the relative factor and a probability that the garbage collection process will be completed the identified target length of time while attempting to maximize an amount of garbage that can be collected; and
initiate garbage collection on the subset of the set of nodes.

2. The computer system of claim 1, wherein identifying a relative factor comprises identifying node hotness which identifies rates at which data is accessed on nodes.

3. The computer system of claim 1, wherein identifying a relative factor comprises identifying when garbage collection was last performed on nodes.

4. The computer system of claim 1, wherein identifying a relative factor comprises identifying storage space on nodes.

5. The computer system of claim 1, wherein the one or more computer-readable media further have stored thereon instructions that are executable by the one or more processors to configure the computer system to generate a warning indicating that the target length of time will not be met if the current subset is garbage collected.

6. The computer system of claim 5, wherein the one or more computer-readable media further have stored thereon instructions that are executable by the one or more processors to configure the computer system to: based on the warning, select a different subset.

7. The computer system of claim 5, wherein the one or more computer-readable media further have stored thereon instructions that are executable by the one or more processors to configure the computer system to: based on the warning, identify independent nodes in the subset and begin garbage collection on the independent nodes in the subset.

8. In cluster, computing environment, a method of scheduling garbage collection operations, the method comprising:
identifying a set of nodes in a cluster;
identifying a relative factor of the nodes in the set of nodes;
identifying a target length of time in which to complete a garbage collection process;
selecting a subset of the set of nodes in which the garbage collection process could be completed in the identified target length of tune, wherein selecting the subset comprises selecting nodes for the garbage collection process based on the relative factor and a probability that the garbage collection process will be completed within the identified target length of time while attempting to maximize an amount of garbage that can be collected; and
initiating garbage collection on the subset of the set of nodes.

9. The method of claim 8, wherein identifying a relative factor comprises identifying node hotness which identifies rates at which data is accessed on nodes.

10. The method of claim 8, wherein identifying a relative factor comprises identifying when garbage collection was last performed on nodes.

11. The method of claim 8, wherein identifying a relative factor comprises identifying storage space on nodes.

12. The method of claim 8, further comprising generating a warning indicating that the target length of time will not be met if the current subset is garbage collected.

13. The method of claim 12, further comprising, based on the warning, selecting a different subset.

14. The method of claim 12, further comprising, based on the warning, identifying independent nodes in the subset and beginning garbage collection on the independent nodes in the subset.

15. A computer system comprising:
a coordinator node, wherein the coordinator node comprises a garbage collector daemon, wherein the garbage collector daemon is configured to:
identify a set of nodes in a cluster;
identify a relative factor of the nodes in the set of nodes;
identify a target length of time in which to complete a garbage collection process;
select a subset of the set of nodes in which the garbage collection process could be completed in the identified target length of time, wherein identifying the subset comprises selecting nodes for the garbage collection process based on the relative factor and a probability that the garbage collection process will be completed within the identified target length of time while attempting to maximize an amount of garbage that can be collected; and
initiate garbage collection on the subset of the set of nodes.

16. The computer system of claim 15, wherein identifying a relative factor comprises identifying node hotness which identifies rates at which data is accessed on nodes.

17. The computer system of claim 15, wherein identifying a relative factor comprises identifying storage space on nodes.

18. The computer system of claim 15, wherein the garbage collector daemon is further configured to generate a warning indicating that the target length of time will not be met if the current subset is garbage collected.

19. The computer system of claim 18, wherein the garbage collector daemon is further configured to based on the warning, select a different subset.

20. The computer system of claim 18, wherein the garbage collector daemon is further configured to based on the warning, identify independent nodes in the subset and begin garbage collection on the independent nodes in the subset.
